(19) United States
(12) Patent Application Publication
(10) Pub. No.: US 2021/0131525 A1
(43) Pub. Date: May 6, 2021

(54) TORQUE FLUCTUATION INHIBITING DEVICE AND POWER TRANSMISSION DEVICE

(71) Applicant: EXEDY Corporation, Osaka (JP)

(72) Inventors: Koichi HIGUCHI, Osaka (JP); Yusuke OKAMACHI, Osaka (JP)

(73) Assignee: EXEDY Corporation

(21) Appl. No.: 16/896,705

(22) Filed: Jun. 9, 2020

(30) Foreign Application Priority Data
Nov. 1, 2019 (JP) 2019-199920

(51) Int. Cl. F16F 15/14; F16H 45/02

(52) U.S. Cl. CPC F16F 15/145; F16H 2045/0263; F16H 45/02

(57) ABSTRACT

A torque fluctuation inhibiting device includes a first rotor including an accommodation portion, a second rotor, a centrifugal element, a guide member, and a cam mechanism. The first rotor is rotatable. The second rotor is rotatable with the first rotor and relative to the first rotor. The centrifugal element is radially movable in the accommodation portion at gaps produced circumferentially therebetween, and receives a centrifugal force generated by rotation of the first or second rotor. The guide member guides radial movement of the centrifugal element. The guide member is movable and rollable between both circumferential end surfaces of the centrifugal element and wall surfaces provided in the accommodation portion to be opposed to the both circumferential end surfaces. The cam mechanism receives the centrifugal force acting on the centrifugal element, and converts the centrifugal force into a circumferential force to reduce rotational phase difference between the first and second rotors.

### CROSS-REFERENCE TO RELATED APPLICATION

This application claims priority to Japanese Patent Application No. 2019-199920, filed on Nov. 1, 2019. The contents of that application are incorporated by reference herein in their entirety.

### TECHNICAL FIELD

The present invention relates to a torque fluctuation inhibiting device and a power transmission device.

### BACKGROUND ART

Torque fluctuation inhibiting devices include an input member and an inertia member. For example, in a torque fluctuation inhibiting device described in Japan Laid-open Patent Application Publication No. 2018-132161, centrifugal elements are disposed in recessed portions of a hub flange, respectively, while being radially movable therein. Each centrifugal element is moved radially outward by a centrifugal force acting thereon in rotation of the hub flange. Besides, each centrifugal element is provided with rollers so as to be radially movable in a smooth manner.

In the torque fluctuation inhibiting device, a hysteresis torque is generated at a friction slide part in accordance with movement of each centrifugal element and so forth. With reduction in energy loss due to the hysteresis torque, the torque fluctuation inhibiting device exerts better vibration inhibiting performance. Because of this, it is especially required to actuate a slide mechanism for moving each centrifugal element in a smooth manner.

A type of slide mechanism realized so far is configured to move each centrifugal element by slipping or rolling with use of a bearing and so forth. However, slide resistance and reduction in lifespan due to abrasion are posed as tasks for sliding realized by slipping. On the other hand, in use of the bearing and so forth, a configuration for supporting the bearing and so forth is made complicated.

### BRIEF SUMMARY

It is an object of the present invention to reduce the magnitude of hysteresis torque generated in accordance with movement of a centrifugal element with a simple configuration.

(1) A torque fluctuation inhibiting device according to a first aspect of the present invention includes a first rotor, a second rotor, a centrifugal element, a guide member and a cam mechanism. The first rotor includes an accommodation portion and is disposed to be rotatable. The second rotor is disposed to be rotatable with the first rotor and be rotatable relative to the first rotor. The centrifugal element is disposed to be radially movable in the accommodation portion at gaps produced circumferentially therebetween. The centrifugal element receives a centrifugal force generated by rotation of the first or second rotor. The guide member guides radial movement of the centrifugal element. The guide member is disposed to be freely movable and rollable between both circumferential end surfaces of the centrifugal element and wall surfaces provided in the accommodation portion in opposition to the both circumferential end surfaces. The cam mechanism receives the centrifugal force acting on the centrifugal element and converts the centrifugal force into a circumferential force directed to reduce rotational phase difference between the first rotor and the second rotor.

According to the configuration, the centrifugal element is radially moved while being guided by the guide member. At this time, the guide member rolls in accordance with movement of the centrifugal element and radially guides the centrifugal element. Because of this, it is possible to reduce the magnitude of hysteresis torque generated in accordance with movement of the centrifugal element. Besides, the guide member is freely movable with respect to the centrifugal element and the accommodation portion. In other words, the guide member is not supported by the centrifugal element and the first rotor including the accommodation portion. Because of this, the configuration of the present device is simplified.

(2) Preferably, the cam mechanism includes a cam surface and a cam follower. The cam surface is provided on the centrifugal element. The cam follower makes contact with the cam surface and transmits a force therethrough between the centrifugal element and the second rotor.

(3) Preferably, the guide member includes rolling elements each made in shape of a needle or ball, and the rolling elements are disposed between the both circumferential end surfaces of the centrifugal element and the wall surfaces provided in the accommodation portion in opposition to the both circumferential end surfaces.

(4) Preferably, the first rotor includes a first stopper restricting the guide member from moving radially outward.

(5) Preferably, the first stopper is a protrusion protruding from each of the wall surfaces provided in the accommodation portion toward corresponding one of the circumferential end surfaces of the centrifugal element.

(6) Preferably, the centrifugal element includes a second stopper restricting the guide member from moving radially inward.

(7) Preferably, the second stopper is a protrusion protruding from each of the both circumferential end surfaces of the centrifugal element toward corresponding one of the wall surfaces provided in the accommodation portion in opposition to the both circumferential end surfaces.

(8) Preferably, the first rotor includes a first protrusion protruding from each of the wall surfaces provided in the accommodation portion toward corresponding one of the both circumferential end surfaces of the centrifugal element. The first protrusion restricts the guide member from moving radially outward. Besides preferably, the centrifugal element includes a second protrusion protruding from each of the both circumferential end surfaces thereof toward corresponding one of the wall surfaces provided in the accommodation portion in opposition to the both circumferential end surfaces. The second protrusion restricts the guide member from moving radially inward. Furthermore, in this case, the centrifugal element is restricted from moving by contact among the guide member, the first protrusion and the second protrusion.

(9) A power transmission device according to a second aspect of the present invention includes an input member, an output member and the torque fluctuation inhibiting device configured as any of the above. The output member is a member to which a torque is transmitted from the input member.

Overall, according to the present invention, it is possible to reduce the magnitude of hysteresis torque generated in accordance with movement of a centrifugal element with a simple configuration.

### BRIEF DESCRIPTION OF THE DRAWINGS

FIG. 1 is a schematic diagram of a torque converter.

FIG. 2 is a perspective view of a torque fluctuation inhibiting device.

FIG. 3 is a partial front view of the torque fluctuation inhibiting device.

FIG. 4 is a partial view of FIG. 2.

FIG. 5 is a partial front view of a centrifugal element, a cam mechanism and a hub flange.

FIG. 6 is a diagram roughly showing a positional relation among the centrifugal element, a cam follower and an inertia ring in a condition without input of torque fluctuations.

FIG. 7 is a diagram roughly showing a positional relation among the centrifugal element, the cam follower and the inertia ring in a condition with input of torque fluctuations.

FIG. 8 is a chart showing exemplary characteristics of the torque fluctuation inhibiting device.

FIG. 9 is a schematic diagram of a damper device.

### DETAILED DESCRIPTION

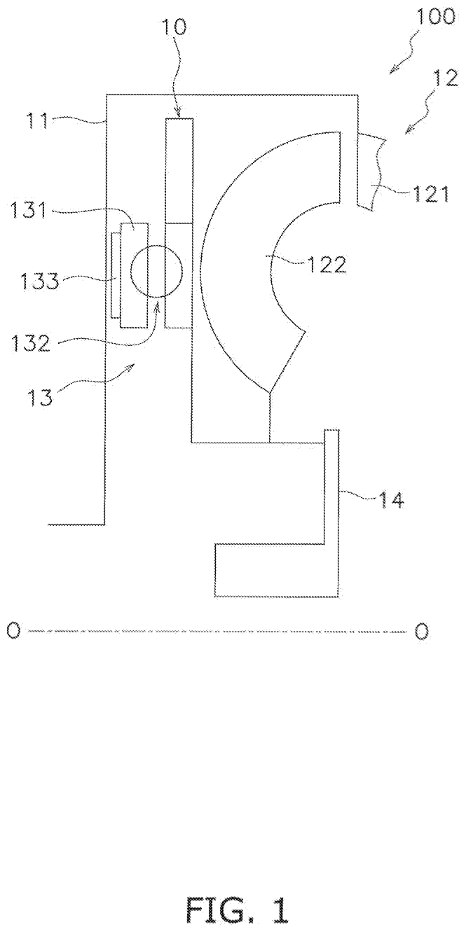

FIG. 1 is a schematic diagram of a torque converter (exemplary power transmission device) according to a preferred embodiment of the present invention. It should be noted that in the following explanation, the term “axial direction” refers to an extending direction of a rotational axis O of the torque fluctuation inhibiting device. On the other hand, the term “circumferential direction” refers to a circumferential direction of an imaginary circle about the rotational axis O, whereas the term “radial direction” refers to a radial direction of the imaginary circle about the rotational axis O. It should be noted that the circumferential direction is not required to be perfectly matched with that of the imaginary circle about the rotational axis O. Likewise, the radial direction is not required to be perfectly matched with a diameter direction of the imaginary circle about the rotational axis O.

### Entire Configuration

As shown in FIG. 1, a torque converter 100 includes a front cover 11, a torque converter body 12, a lock-up device 13 and an output hub 14 (exemplary output member). The front cover 11 is a member to which a torque is inputted from an engine. The torque converter body 12 includes an impeller 121 coupled to the front cover 11, a turbine 122 and a stator (not shown in the drawings). The turbine 122 is coupled to the output hub 14. An input shaft of a transmission (not shown in the drawings) is spline-coupled to the output hub 14.

### Lock-up Device 13

The lock-up device 13 includes a clutch part, a piston to be actuated by hydraulic pressure, and so forth, and can be set to a lock-up on state and a lock-up off state. In the lock-up on state, the torque inputted to the front cover 11 is transmitted to the output hub 14 through the lock-up device 13 without through the torque converter body 12. On the other hand, in the lock-up off state, the torque inputted to the front cover 11 is transmitted to the output hub 14 through the torque converter body 12.

The lock-up device 13 includes an input-side rotor 131 (exemplary input member), a damper 132 and a torque fluctuation inhibiting device 10.

The input-side rotor 131 includes the piston axially movable and is provided with a friction member 133 fixed to the front cover 11—side lateral surface thereof. When the friction member 133 is pressed onto the front cover 11, the torque is transmitted from the front cover 11 to the input-side rotor 131.

The damper 132 is disposed between the input-side rotor 131 and a hub flange 2 (to be described). The damper 132 includes a plurality of torsion springs and elastically couples the input-side rotor 131 and the hub flange 2 in the circumferential direction. The damper 132 transmits the torque from the input-side rotor 131 to the hub flange 2, and besides, absorbs and attenuates torque fluctuations.

### Torque Fluctuation Inhibiting Device 10

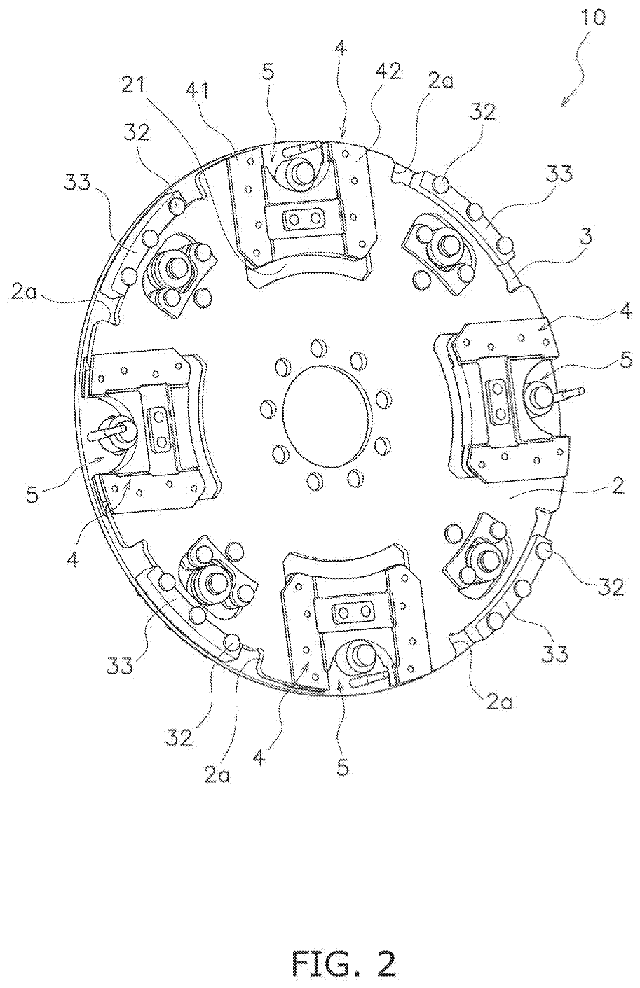

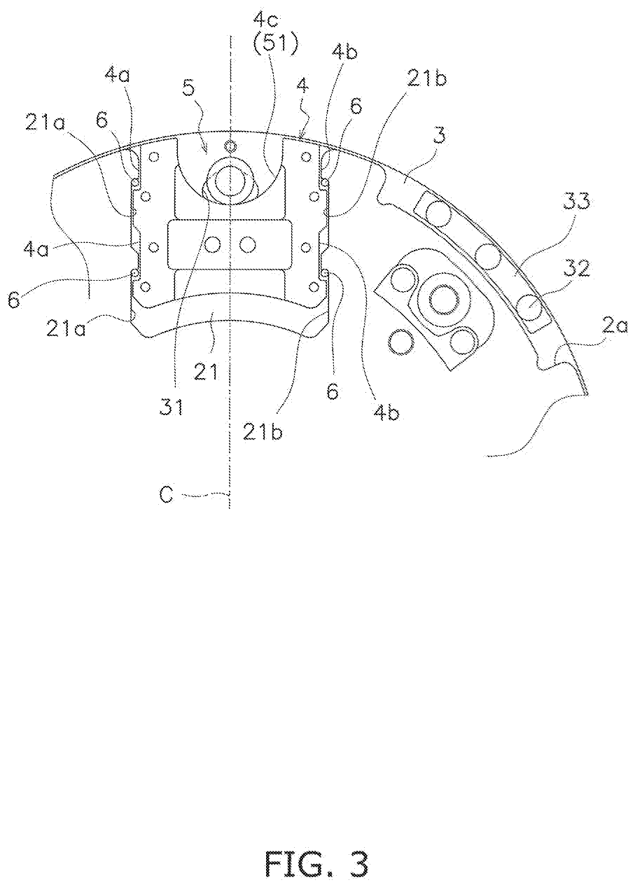

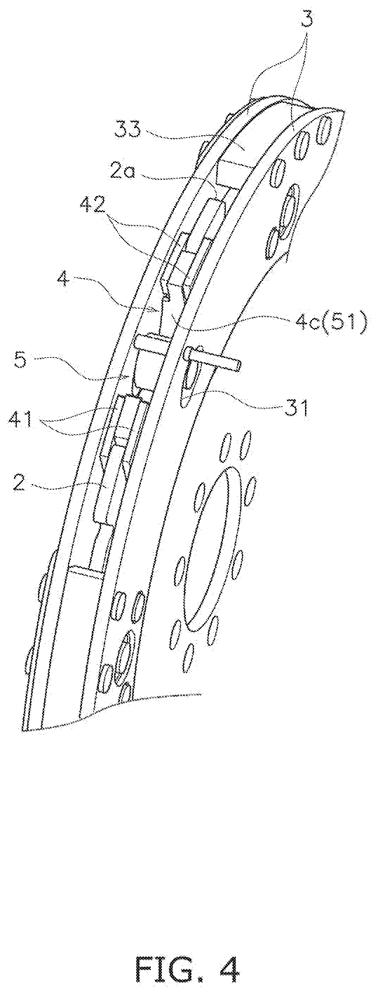

FIG. 2 is a perspective view of the torque fluctuation inhibiting device 10. FIG. 3 is a partial front view of the torque fluctuation inhibiting device 10. FIG. 4 is a perspective view of part of the torque fluctuation inhibiting device 10 seen at a different angle from FIG. 2. It should be noted that in FIGS. 2 and 3, one of inertia rings 3 (near-side inertia ring 3) is detached.

As shown in FIGS. 2 to 4, the torque fluctuation inhibiting device 10 includes a hub flange 2 (exemplary first rotor), a pair of inertia rings 3 (exemplary second rotor), a plurality of centrifugal elements 4, a plurality of cam mechanisms 5 and a plurality of needle rollers 6 (exemplary guide member; see FIG. 3). It should be herein noted that the term “needle rollers” means not “a needle roller bearing”, in which a plurality of needle rollers are held by a holder, but needle rollers provided as independent elements without being held by the holder.

### Hub Flange 2

The hub flange 2 is disposed to be rotatable. The hub flange 2 is disposed in axial opposition to the input-side rotor 131. The hub flange 2 is rotatable relative to the input-side rotor 131. The hub flange 2 is coupled to the output hub 14. In other words, the hub flange 2 is unitarily rotated with the output hub 14. It should be noted that the hub flange 2 can be integrated with the output hub 14 as a single member.

The hub flange 2 has a disc shape. As described above, the hub flange 2 is coupled at the inner peripheral part thereof to the output hub 14. The hub flange 2 is provided with four accommodation portions 21 in the outer peripheral part thereof. Each accommodation portion 21 is recessed radially inward by a predetermined depth. Each accommodation portion 21 is opened radially outward. Each accommodation portion 21 is provided with wall surfaces 21a and 21b on the both circumferential ends thereof. As shown in FIG. 3, each wall surface 21a, 21b is shaped in parallel to a center line C.

### Inertia Rings 3

As shown in FIGS. 2 to 4, each inertia ring 3 is an annular plate. Detailedly, each inertia ring 3 is made in the shape of a continuous annulus. The pair of inertia rings 3 functions as a mass body of the torque fluctuation inhibiting device 10. The pair of inertia rings 3 is disposed to interpose the hub flange 2 therebetween. The pair of inertia rings 3 is disposed axially on the both sides of the hub flange 2 such that a predetermined gap is produced between the hub flange 2 and each inertia ring 3. In other words, the hub flange 2 and the pair of inertia rings 3 are disposed in axial alignment. The pair of inertia rings 3 has a rotational axis common to the hub flange 2. The pair of inertia rings 3 is rotatable with the hub flange 2 and is also rotatable relative to the hub flange 2 within a predetermined angular range.

Each inertia ring 3 includes a plurality of through holes 31. The through holes 31 penetrate each inertia ring 3 in the axial direction. Each through hole 31 has a diameter greater than that of each of a pair of small diameter portions 522 of each cam follower 52 (to be described). Besides, the diameter of each through hole 31 is less than that of a large diameter portion 521 of each cam follower 52.

The pair of inertia rings 3 is fixed to each other by a plurality of rivets 32. Therefore, the pair of inertia rings 3 is axially, radially and circumferentially immovable relative to each other. In other words, the pair of inertia rings 3 is unitarily rotated with each other.

A plurality of inertia blocks 33 are disposed between the pair of inertia rings 3. The plural inertia blocks 33 are disposed away from each other at intervals in the circumferential direction. Each inertia block 33 composes part of a torsion stopper mechanism 8 (to be described). The inertia blocks 33 and the centrifugal elements 4 are alternately disposed in the circumferential direction. The inertia blocks 33 are fixed to the pair of inertia rings 3. Specifically, the inertia blocks 33 are fixed to the pair of inertia rings 3 by the rivets 32. It should be noted that each inertia block 33 has a thickness greater than that of each centrifugal element 4.

### Centrifugal Elements 4

Each centrifugal element 4 is disposed inside each accommodation portion 21 of the hub flange 2. Each centrifugal element 4 is made radially movable by a centrifugal force generated by rotation of the hub flange 2. Each centrifugal element 4 is shaped to extend in the circumferential direction. Each centrifugal element 4 is provided with end surfaces 4a and 4b on the both circumferential ends thereof. The end surfaces 4a and 4b are opposed to the wall surfaces 21a and 21b of each accommodation portion 21, respectively. In more detail, each end surface 4a, 4b is shaped in parallel to each wall surface 21a, 21b of each accommodation portion 21 at a predetermined gap.

As shown in FIGS. 2 and 4, a pair of side plates 41 is fixed to the both axial lateral surfaces of one circumferential end of each centrifugal element 4, while a pair of side plates 42 is fixed to the both axial lateral surfaces of the other circumferential end of each centrifugal element 4. It should be noted that the pair of side plates 41 and the pair of side plates 42 are detached in FIG. 3. As is obvious from FIG. 4, each pair of side plates 41, 42 interposes part of the hub flange 2 (specifically, each of the circumferential edges of each accommodation portion 21) at the circumferential distal ends thereof. Besides, the pair of side plates 41 radially covers the entirety of one circumferential end of each centrifugal element 4, while the pair of side plates 42 radially covers the entirety of the other circumferential end of each centrifugal element 4. Because of this, the needle rollers 6 are made axially immovable by the pair of side plates 41 and the pair of side plates 42.

It should be noted that an outer peripheral surface 4c of each centrifugal element 4 dents in a circular-arc shape to the inner peripheral side, and as described below, functions as a cam surface 51.

### Needle Rollers 6

The needle rollers 6 are disposed between each of the wall surfaces 21a and 21b of each accommodation portion 21 and corresponding one of the end surfaces 4a and 4b of each centrifugal element 4. Two needle rollers 6 are disposed between each wall surface 21a, 21b and each end surface 4a, 4b such that one is disposed on a radially outer side whereas the other is disposed on a radially inner side. The needle rollers 6 are radially movable within a predetermined range by rolling against each wall surface 21a, 21b and each end surface 4a, 4b opposed to each other. Besides, the needle rollers 6 are also movable by sliding against each end surface 4a, 4b of each centrifugal element 4.

The needle rollers 6 are freely movable without being supported by any of the hub flange 2, the pair of inertia rings 3 and each centrifugal element 4. Besides, the needle rollers 6 make each centrifugal element 4 radially movable in a smooth manner. It should be noted that as described above, the needle rollers 6 are made axially immovable by the pair of side plates 41 and the pair of side plates 42, both of which are fixed to the both circumferential ends of each centrifugal element 4, respectively.

### Roller Stopper Mechanisms 7

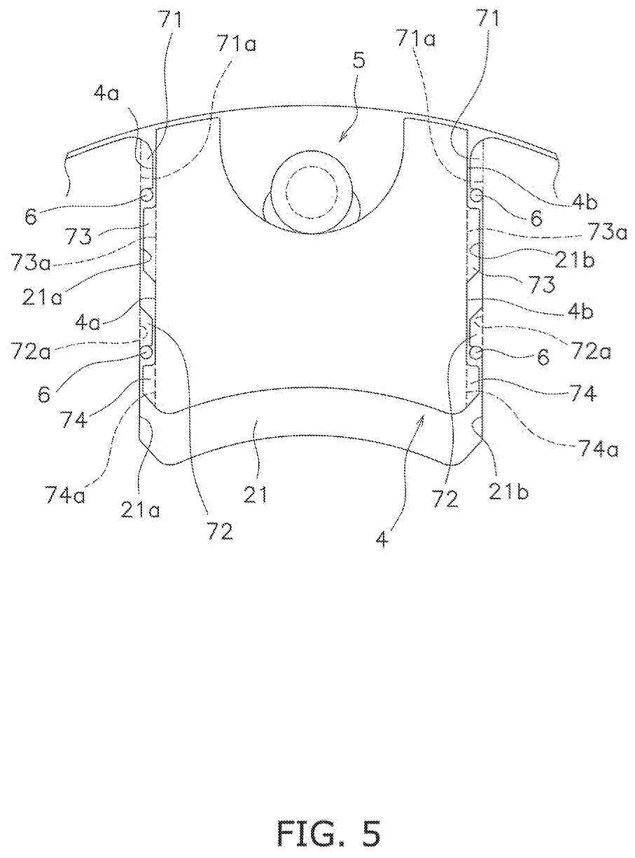

The torque fluctuation inhibiting device 10 includes roller stopper mechanisms 7 for restricting the needle rollers 6 from radially moving. As shown in FIG. 5, each roller stopper mechanism 7 includes first and second protrusions 71 and 72 (exemplary first stopper) provided on the hub flange 2 and third and fourth protrusions 73 and 74 (exemplary second stopper) provided on each centrifugal element 4. It should be noted that FIG. 5 shows each centrifugal element 4 in a simplified manner.

The first protrusions 71 are provided on a radially outer end of each accommodation portion 21, while being shaped to protrude from the wall surfaces 21a and 21b toward each centrifugal element 4. The second protrusions 72 are provided on the radially inner side of the first protrusions 71, while being shaped to protrude from the wall surfaces 21a and 21b toward each centrifugal element 4. Each protrusion 71, 72 protrudes at a height enough to avoid contact with corresponding one of the end surfaces 4a and 4b of each centrifugal element 4. It should be noted that each protrusion 71, 72 is provided with a groove 71a, 72a radially penetrating therethrough.

The third protrusions 73 are provided on a radially intermediate part of each centrifugal element 4, while being shaped to protrude from the end surfaces 4a and 4b toward the wall surfaces 21a and 21b of each accommodation portion 21. The fourth protrusions 74 are provided on a radially inner end of each centrifugal element 4, while being shaped to protrude from the end surfaces 4a and 4b toward the wall surfaces 21a and 21b of each accommodation portion 21. Each protrusion 73, 74 protrudes at a height enough to avoid contact with corresponding one of the wall surfaces 21a and 21b of each accommodation portion 21. It should be noted that each protrusion 73, 74 is provided with a groove 73a, 74a radially penetrating therethrough.

In the configuration described above, the needle rollers 6 are moved to the outer peripheral side by centrifugal forces acting thereon. However, this movement is restricted by the first and second protrusions 71 and 72. On the other hand, when the device is stopped or rotated at an extremely low speed, the needle rollers 6 located up are moved down (to the inner peripheral side). However, this movement is restricted by the third and fourth protrusions 73 and 74.

Now, it can be assumed that the present device is actuated while being filled with material with high viscosity such as oil or so forth. When the device is actuated in this assumption, change in volume occurs in spaces accommodating the needle rollers 6 (each of which is a space enclosed by the respective protrusions 71 to 74, each wall surface 21a, 21b of each accommodation portion 21 and each end surface 4a, 4b of each centrifugal element 4). In such a situation, it is concerned that attenuation occurs due to viscous resistance as seen in a piston cylinder mechanism and this results in degradation in effect of inhibiting torque fluctuations.

However, in the present preferred embodiment, the protrusions 71 to 74 are provided with the grooves 71a to 74a radially penetrating therethrough, respectively. Hence, viscous fluid such as oil, residing in the respective spaces, is discharged radially outward through the grooves 71a to 74a. Therefore, degradation in effect of inhibiting torque fluctuations described above can be inhibited.

Besides, each roller stopper mechanism 7 also has a function of restricting each centrifugal element 4 from radially moving.

In other words, each centrifugal element 4 is moved radially outward by a centrifugal force acting thereon. However, the third and fourth protrusions 73 and 74 of each centrifugal element 4 make contact with the first and second protrusions 71 and 72 of the hub flange 2, respectively, while the needle rollers 6 are interposed therebetween. Because of this, each centrifugal element 4 is restricted from moving radially outward.

Furthermore, when the device is stopped or rotated at the extremely low speed, each centrifugal element 4 located up is moved down (to the inner peripheral side). However, the third protrusions 73 of each centrifugal element 4 make contact with the second protrusions 72 of the hub flange 2. This restricts movement of each centrifugal element 4, whereby each centrifugal element 4 can be prevented from colliding with the bottom surface of each accommodation portion 21.

### Cam Mechanisms 5

Each cam mechanism 5 is configured to receive a centrifugal force acting on each centrifugal element 4 and convert the centrifugal force into a circumferential force directed to reduce rotational phase difference between the hub flange 2 and the pair of inertia rings 3. It should be noted that each cam mechanism 5 functions when the rotational phase difference is produced between the hub flange 2 and the pair of inertia rings 3.

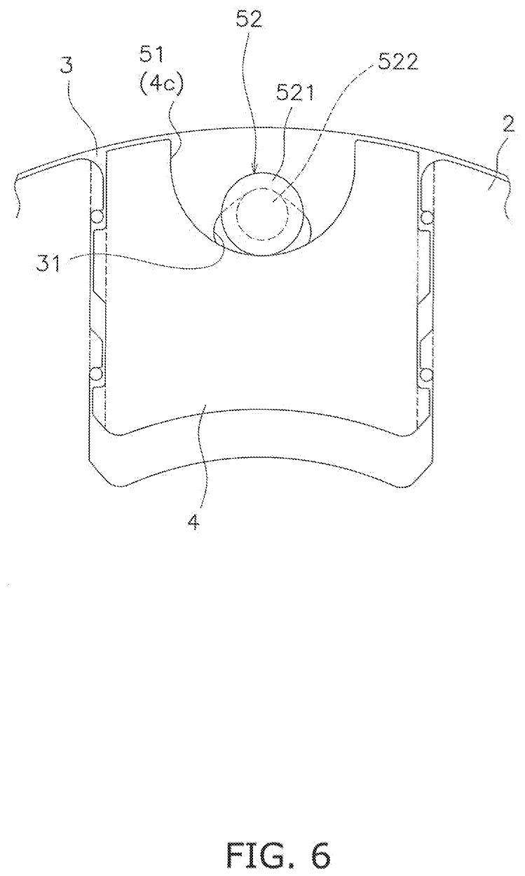

As shown in FIG. 6, each cam mechanism 5 includes the cam surface 51 and the cam follower 52. As described above, the cam surface 51 is provided on the outer peripheral surface 4c of each centrifugal element 4. The cam surface 51 is a surface with which the cam follower 52 makes contact. The cam surface 51 is made in the shape of a circular arc denting radially inward as seen in the axial direction. The cam surface 51 faces radially outward.

The cam follower 52 makes contact with the cam surface 51. The cam follower 52 is configured to transmit a force therethrough between each centrifugal element 4 and the pair of inertia rings 3. The cam follower 52 extends inside each pair of through holes 31 of the pair of inertia rings 3. The cam follower 52 is attached to the pair of inertia rings 3, while being rotatable about a rotational axis thereof.

The cam follower 52 is interposed between the cam surface 51 and the inner wall surfaces of each pair of through holes 31 of the pair of inertia rings 3. The cam follower 52 rolls not only on the cam surface 51 but also on the inner wall surfaces of each pair of through holes 31 of the pair of inertia rings 3. Detailedly, the cam follower 52 makes contact with the cam surface 51 on the radially inner side, while making contact with the inner wall surfaces of each pair of through holes 31 of the pair of inertia rings 3 on the radially outer side. This results in positioning of the cam follower 52. Moreover, the cam follower 52 transmits a force therethrough between each centrifugal element 4 and the pair of inertia rings 3 due to the configuration that the cam follower 52 is interposed between the cam surface 51 and the inner wall surfaces of each pair of through holes 31 of the pair of inertia rings 3.

The cam follower 52 is provided as a roller made in the shape of a column (solid cylinder). In other words, the cam follower 52 is not a bearing. The cam follower 52 includes the large diameter portion 521 and the pair of small diameter portions 522. The center of the large diameter portion 521 and that of each small diameter portion 522 are matched with each other. The large diameter portion 521 has a diameter greater than that of each small diameter portion 522. The diameter of the large diameter portion 521 is greater than that of each through hole 31. The large diameter portion 521 rolls on the cam surface 51.

The pair of small diameter portions 522 axially protrudes to the both sides from the large diameter portion 521. The pair of small diameter portions 522 rolls on the inner wall surfaces of each pair of through holes 31 of the pair of inertia rings 3. Each small diameter portion 522 has a diameter less than that of each through hole 31. The cam follower 52 can be provided as a single member. It should be noted that the cam follower 52 can be made in the shape of a cylinder (hollow cylinder).

When rotational phase difference is produced between the hub flange 2 and the pair of inertia rings 3 by the contact between the cam follower 52 and the cam surface 51 and the contact between the cam follower 52 and the inner wall surfaces of each pair of through holes 31 of the pair of inertia rings 3, the centrifugal force generated in each centrifugal element 4 is converted into the circumferential force by which the rotational phase difference is reduced.

### Torsion Stopper Mechanisms 8

The torque fluctuation inhibiting device 10 further includes torsion stopper mechanisms 8. The torsion stopper mechanisms 8 restrict an angular range of relative rotation between the hub flange 2 and the pair of inertia rings 3. As shown in FIGS. 2 to 4, each torsion stopper mechanism 8 includes each of cutouts 2a provided on the hub flange 2 and each of the inertia blocks 33 fixed to the pair of inertia rings 3.

Each cutout 2a is provided on the outer peripheral end of the hub flange 2 so as to be opened radially outward. Each cutout 2a has a predetermined length in the circumferential direction. Each inertia block 33 is fixed to the inner sides (the lateral surfaces facing each other) of the outer peripheral ends of the pair of inertia rings 3. Each inertia block 33 is disposed inside each cutout 2a.

In the configuration described above, the angular range of relative rotation between the hub flange 2 and the pair of inertia rings 3 is restricted by the contact between one of circumferential end surfaces of each inertia block 33 and that of each cutout 2a.

### Actuation of Torque Fluctuation Inhibiting Device 10

In the lock-up on state of the torque converter 100, a torque transmitted to the front cover 11 is transmitted to the hub flange 2 through the input-side rotor 131 and the damper 132.

When torque fluctuations do not exist in torque transmission, the hub flange 2 and the pair of inertia rings 3 are rotated in a condition shown in FIG. 6. In this condition, the cam follower 52 in each cam mechanism 5 makes contact with the radial innermost position (circumferential middle position) of the cam surface 51. Besides, in this condition, the rotational phase difference between the hub flange 2 and the pair of inertia rings 3 is “0”.

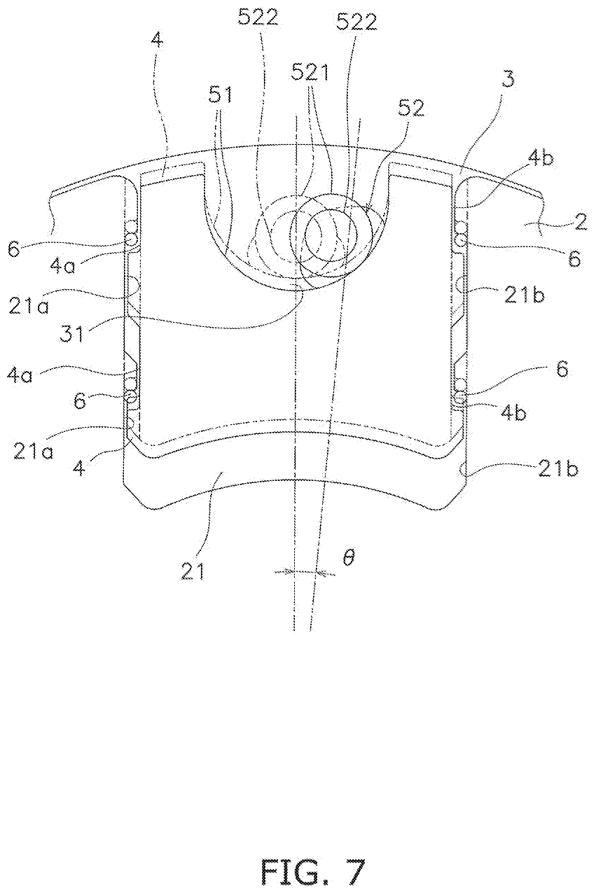

As described above, the circumferential relative displacement between the hub flange 2 and the pair of inertia rings 3 is referred to as “rotational phase difference”. In FIGS. 6 and 7, these terms indicate displacement between the circumferential middle position of both each centrifugal element 4 and the cam surface 51 and the center position of each pair of through holes 31 of the pair of inertia rings 3.

When torque fluctuations herein exist in torque transmission, rotational phase difference θ is produced between the hub flange 2 and the pair of inertia ring 3 as shown in FIG. 7.

As shown in FIG. 7, when the rotational phase difference θ is produced between the hub flange 2 and the pair of inertia rings 3, the com follower 52 in each cam mechanism 5 is moved from a position shown in FIG. 6 to a position shown in FIG. 7. At this time, the cam follower 52 is relatively moved to the right side while rolling on the cam surface 51. Besides, the cam follower 52 also rolls on the inner wall surfaces of each pair of through holes 31 of the pair of inertia rings 3. Detailedly, the large diameter portion 521 of the cam follower 52 rolls on the cam surface 51, whereas the pair of small diameter portions 522 of the cam follower 52 rolls on the inner wall surfaces of each pair of through holes 31 of the pair of inertia rings 3.

When moved rightward, the cam follower 52 presses each centrifugal element 4 radially inward (downward in FIGS. 6 and 7) through the cam surface 51, whereby each centrifugal element 4 is moved radially inward. As a result, each centrifugal element 4 is moved from a position shown in FIG. 6 to a position shown in FIG. 7. At this time, each centrifugal element 4 is moved radially inward while being guided by the needle rollers 6 rolling along the wall surfaces 21a and 21b of each accommodation portion 21 and the end surfaces 4a and 4b of each centrifugal element 4.

However, a centrifugal force is acting on each centrifugal element 4. Hence, each centrifugal element 4 is moved radially outward (upward in FIG. 7). Similarly to the above, each centrifugal element 4 is herein also moved radially outward while being guided by the needle rollers 6 rolling along the wall surfaces 21a and 21b of each accommodation portion 21 and the end surfaces 4a and 4b of each centrifugal element 4.

When each centrifugal element 4 is moved radially outward, the cam surface 51 provided on each centrifugal element 4 presses the pair of inertia rings 3 through the cam follower 52 to the left side in FIG. 7, whereby the pair of inertia rings 3 is moved to the left side in FIG. 7. At this time, the large diameter portion 521 of the cam follower 52 rolls on the cam surface 51, whereas the pair of small diameter portions 522 of the cam follower 52 rolls on the inner wall surfaces of each pair of through holes 31 of the pair of inertia rings 3. As a result, the condition shown in FIG. 7 with dashed two-dotted line (the condition shown in FIG. 6) is restored.

It should be noted that when the rotational phase difference is reversely produced, the cam follower 52 is relatively moved along the cam surface 51 to the left side in FIG. 7. However, the actuation principle described above is also true of this case.

As described above, when the rotational phase difference is produced between the hub flange 2 and the pair of inertia rings 3 by torque fluctuations, the hub flange 2 receives the circumferential force directed to reduce the rotational phase difference between the both by the centrifugal force acting on each centrifugal element 4 and the working of each cam mechanism 5. Torque fluctuations are inhibited by this force.

The aforementioned force inhibiting torque fluctuations varies in accordance with the centrifugal force, in other words, the rotational speed of the hub flange 2, and also varies in accordance with the rotational phase difference and the shape of the cam surface 51. Therefore, by suitably setting the shape of the cam surface 51, characteristics of the torque fluctuation inhibiting device 10 can be made optimal in accordance with the specification of the engine and so forth.

### Actuation of Needle Rollers 6

In such a torsional motion (performed when relative rotation occurs between the hub flange 2 and the pair of inertia rings 3) as described above, loads due to pressing and frictional forces due to the loads are generated between the needle rollers 6 and the slide surfaces (the wall surfaces 21a and 21b of each accommodation portion 21 and the end surfaces 4a and 4b of each centrifugal element 4).

At this time, when the centrifugal forces acting on the needle rollers 6 are greater in magnitude than the frictional forces, the needle rollers 6 make contact with the first and second protrusions 71 and 72 of the hub flange 2. Accordingly, each centrifugal element 4 is moved while sliding against the needle rollers 6 (sliding motion).

By contrast, in the torsional motion, when the friction forces between the needle rollers 6 and the slide surfaces are greater in magnitude than the centrifugal forces acting on the needle rollers 6, the radial positions of the needle rollers 6 are kept unchanged by the frictional forces. In this case, the needle rollers 6 roll between the slide surfaces in accordance with movement of each centrifugal element (rolling motion). Radial movement of each centrifugal element 4 is made smooth by the rolling of the needle rollers 6.

Based on the above, it is preferable to make each needle roller 6 lightweight, and it is possible to narrow the range of sliding motion and widen the range of rolling motion with reduction in magnitude of centrifugal force.

### Exemplary Characteristics

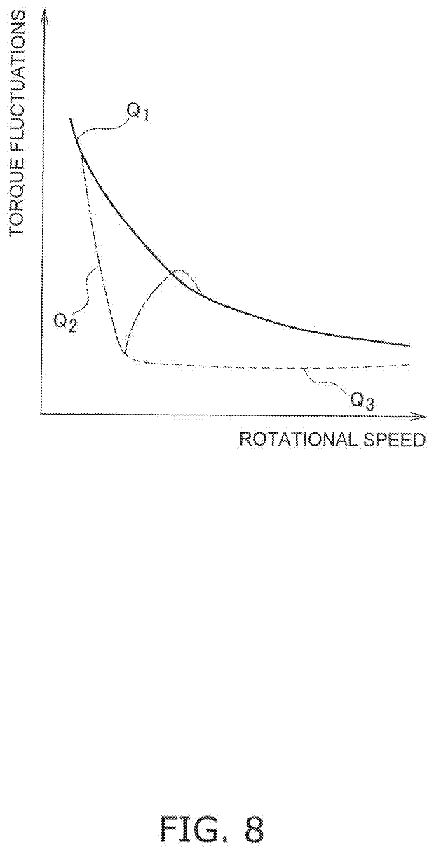

FIG. 8 is a diagram showing exemplary characteristics of the torque fluctuation inhibiting device 10. The horizontal axis indicates rotational speed, whereas the vertical axis indicates torque fluctuations (rotational speed fluctuations). Characteristic Q1 indicates a condition without installation of a device for inhibiting torque fluctuations; characteristic Q2 indicates a condition with installation of a well-known dynamic damper device without any cam mechanism; and characteristic Q3 indicates a condition with installation of the torque fluctuation inhibiting device 10 of the present preferred embodiment.

As is obvious from FIG. 8, in an apparatus in which the well-known dynamic damper device without any cam mechanism is installed (characteristic Q2), torque fluctuations can be inhibited only in a specific rotational speed range. By contrast, in the condition with installation of the torque fluctuation inhibiting device 10 with the cam mechanisms 5 of the present preferred embodiment (characteristic Q3), torque fluctuations can be inhibited through the entire rotational speed ranges.

### Modifications

The present invention is not limited to the preferred embodiment described above, and a variety of changes or modifications can be made without departing from the scope of the present invention.

### Modification 1

The shape of each centrifugal element 4 is not limited to that in the aforementioned preferred embodiment. In other words, as long as each centrifugal element 4 is provided with the cam surface and the end surfaces on which the needle rollers roll, the shape of the other part of each centrifugal element 4 is not limited to a particular shape.

### Modification 2

Each cam follower 52 can be attached to each pair of through holes 31 of the pair of inertia rings 3 through a pair of bearing members.

### Modification 3

In the aforementioned preferred embodiment, the hub flange 2 is provided with the centrifugal elements 4. Alternatively, the pair of inertia rings 3 can be provided with the centrifugal elements 4. In this case, the pair of inertia rings 3 corresponds to the first rotor of the present invention, whereas the hub flange 2 corresponds to the second rotor of the present invention.

### Modification 4

In the aforementioned preferred embodiment, the hub flange 2 has been exemplified as the first rotor. However, the first rotor is not limited to the above. For example, when a torque fluctuation inhibiting device is attached to a torque converter as configured in the present preferred embodiment, the front cover 11, the input-side rotor 131 or so forth can be set as the first rotor in the torque converter 100.

### Modification 5

In the aforementioned preferred embodiment, the needle rollers have been exemplified as the guide members. However, balls can be used as the guide members. This configuration will be shown by diagrams similar to those of the aforementioned preferred embodiment.

### Modification 6

In the aforementioned preferred embodiment, the torque fluctuation inhibiting device 10 is attached to the torque converter 100. Alternatively, the torque fluctuation inhibiting device 10 can be attached to another type of power transmission device such as a clutch device.

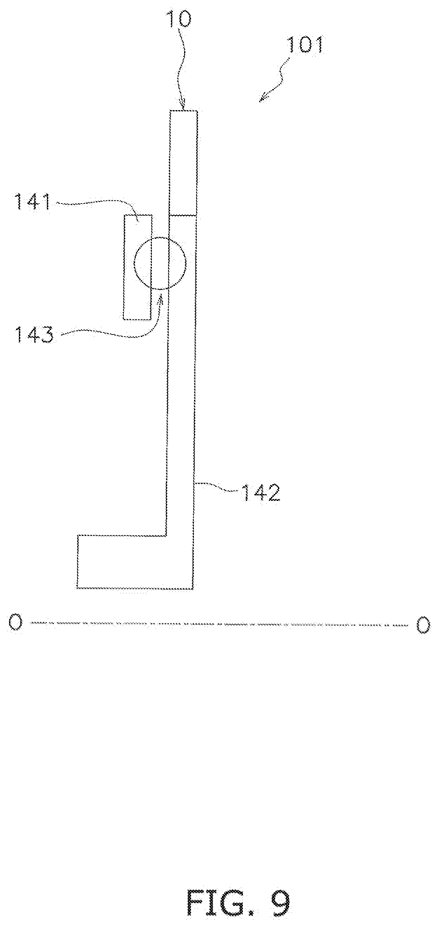

For example, as shown in FIG. 9, the torque fluctuation inhibiting device 10 can be attached to a damper device 101. The damper device 101 is installed in, for instance, a hybrid vehicle. The damper device 101 includes an input member 141, an output member 142, a damper 143 and the torque fluctuation inhibiting device 10. The input member 141 is a member to which a torque is inputted from a drive source. The damper 143 is disposed between the input member 141 and the output member 142. The output member 142 is a member to which the torque is transmitted from the input member 141 through the damper 143. The torque fluctuation inhibiting device 10 is attached to, for instance, the output member 142.

### REFERENCE SIGNS LIST

1 Hub flange
21 Accommodation portion
21a, 21b Wall surface of accommodation portion
3 Inertia ring
4 Centrifugal element
4a, 4b End surface of centrifugal element
5 Cam mechanism
51 Cam surface
52 Cam follower
6 Needle roller
7 Roller stopper mechanism
71, 72 First/second protrusion
73, 74 Third/fourth protrusion

What is claimed is:

1. A torque fluctuation inhibiting device comprising:
a first rotor including an accommodation portion, the first rotor disposed to be rotatable;
a second rotor disposed to be rotatable with the first rotor and be rotatable relative to the first rotor;
a centrifugal element disposed to be radially movable in the accommodation portion at gaps produced circumferentially therebetween, the centrifugal element configured to receive a centrifugal force generated by rotation of the first or second rotor;
a guide member configured to guide radial movement of the centrifugal element, the guide member disposed to be freely movable and rollable between both circumferential end surfaces of the centrifugal element and wall surfaces provided in the accommodation portion to be opposed to the both circumferential end surfaces; and
a cam mechanism configured to receive the centrifugal force acting on the centrifugal element, the cam mechanism further configured to convert the centrifugal force into a circumferential force directed to reduce rotational phase difference between the first rotor and the second rotor.

2. The torque fluctuation inhibiting device according to claim 1, wherein
the cam mechanism includes
a cam surface provided on the centrifugal element, and
a cam follower configured to make contact with the cam surface, the cam follower further configured to transmit a force therethrough between the centrifugal element and the second rotor.

3. The torque fluctuation inhibiting device according to claim 1, wherein the guide member includes rolling elements each having a shape of a needle or ball, the rolling elements disposed between the both circumferential end surfaces of the centrifugal element and the wall surfaces provided in the accommodation portion to be opposed to the both circumferential end surfaces.

4. The torque fluctuation inhibiting device according to claim 1, wherein the first rotor includes a first stopper configured to restrict the guide member from moving radially outward.

5. The torque fluctuation inhibiting device according to claim 4, wherein the first stopper is a protrusion protruding from each of the wall surfaces provided in the accommodation portion toward corresponding one of the circumferential end surfaces of the centrifugal element.

6. The torque fluctuation inhibiting device according to claim 1, wherein the centrifugal element includes a second stopper configured to restrict the guide member from moving radially inward.

7. The torque fluctuation inhibiting device according to claim 6, wherein the second stopper is a protrusion protruding from each of the both circumferential end surfaces of the centrifugal element toward corresponding one of the wall surfaces provided in the accommodation portion to be opposed to the both circumferential end surfaces.

8. The torque fluctuation inhibiting device according to claim 1, wherein
the first rotor includes a first protrusion protruding from each of the wall surfaces provided in the accommodation portion toward corresponding one of the both circumferential end surfaces of the centrifugal element, the first protrusion configured to restrict the guide member from moving radially outward,
the centrifugal element includes a second protrusion protruding from each of the both circumferential end surfaces thereof toward corresponding one of the wall surfaces provided in the accommodation portion to be opposed to the both circumferential end surfaces, the second protrusion configured to restrict the guide member from moving radially inward, and
the centrifugal element is restricted from moving by contact among the guide member, the first protrusion and the second protrusion.

9. A power transmission device comprising:
an input member;
an output member to which a torque is transmitted from the input member; and
the torque fluctuation inhibiting device recited in claim 1.
